(19) United States
(12) Patent Application Publication
(10) Pub. No.: US 2015/0317124 A1
(43) Pub. Date: Nov. 5, 2015

(54) AUDIO INTERACTION METHOD, APPARATUS, AND SYSTEM

(71) Applicant: TENCENT TECHNOLOGY (SHENZHEN) COMPANY LIMITED, Shenzhen City, Guangdong (CN)

(72) Inventors: Pengcheng HUANG, Shenzhen (CN); Guang CHEN, Shenzhen (CN); Lin YANG, Shenzhen (CN); Cheng ZHONG, Shenzhen (CN); Jia WEI, Shenzhen (CN); Hui MA, Shenzhen (CN); Nan WANG, Shenzhen (CN); Yinfeng HUANG, Shenzhen (CN); Shumin LEI, Shenzhen (CN); Jiaao YU, Shenzhen (CN); Xiang ZHANG, Shenzhen (CN); Qi TIAN, Shenzhen (CN)

(73) Assignee: TENCENT TECHNOLOGY (SHENZHEN) COMPANY LIMITED, Shenzhen, Guangdong (CN)

(21) Appl. No.: 14/440,223

(22) PCT Filed: Oct. 29, 2013
(86) PCT No.: PCT/CN13/86123

§ 371 Date: May 1, 2015

(30) Foreign Application Priority Data
Nov. 1, 2012 (CN) 201210430969.3

(51) Int. Cl. G06F 3/16; G10L 19/00; G06F 17/30

(52) U.S. Cl. CPC G06F 3/165; G06F 17/30743; G06F 17/30719; G10L 19/0017

(57) ABSTRACT

Implementation manners of the present disclosure provide an audio interaction method, apparatus, and system. The method includes: determining a user attribute tag, and grouping users into N groups based on the user attribute tag, N being a positive integer that at least is 2; recording an audio file of a user, and extracting decibel information of the audio file of the user from the recorded audio file of the user; and comparing the extracted decibel information of the audio file of the user with decibel information of a user in another group different from a group the user is in, and presenting a comparison result. In the implementation manners of the present disclosure, interaction between grouped users is achieved in an audio manner, therefore, interactive effect is better, and interactive efficiency is improved.

### RELATED APPLICATION

This application claims priority to Chinese Patent Application No. 201210430969.3, filed with the Chinese Patent Office on Nov. 1, 2012 and entitled “AUDIO INTERACTION METHOD, APPARATUS, AND SYSTEM”, which is incorporated herein by reference in its entirety.

### FIELD OF THE TECHNOLOGY

Implementation manners of the present disclosure relate to the field of information processing technologies, and in particular, to an audio interaction method, apparatus, and system.

### BACKGROUND OF THE DISCLOSURE

With the rapid development of computer technologies and network technologies, the Internet and instant messaging (IM) technologies are increasingly influential in people's everyday life, study, and work. In addition, as the mobile Internet develops, the Internet also develops to be mobile. Intelligent terminals (Smartphones) refer to a general name of mobile phones that have an independent operating system like a personal computer (PC), in which users can install by themselves programs, such as software or games, provided by a third-party service provider, and that can be connected to a wireless network by using a mobile communications network, where such programs are used to extend functions of the mobile phones.

At present, generally, there are interactive applications for sports games in some application programs of an intelligent terminal, and existing interactive manners mainly include a text chat and voting. In the both implementation manners, backend operation personnel create a poll or a chat room to be bound to a sports game by using a database (such as mysql); and when a user enters a game interface, the user submits text information in a text manner, for example, by using the Hypertext Transfer Protocol (HTTP), to a backend server to complete interaction.

However, in various existing interactive manners, either a text chat or voting is presented in a form of a text, and interaction is not targeted. As a result, an interactive format and interactive content are very simple without fully using advantages of multimedia, and therefore, an interactive effect is poor, and interactive efficiency is low.

In addition, it is difficult to share, in other application platforms, interaction data generated in existing interactive manners, which therefore is adverse to efficient data integration.

### SUMMARY

An implementation manner of the present disclosure provides an audio interaction method, which achieves targeted interaction in an audio manner, thereby improving an interactive effect, and improving interactive efficiency.

An implementation manner of the present disclosure further provides an audio interaction apparatus, which achieves targeted interaction in an audio manner, thereby improving an interactive effect, and improving interactive efficiency.

An implementation manner of the present disclosure further provides an audio interaction system, which achieves targeted interaction in an audio manner, thereby improving an interactive effect, and improving interactive efficiency.

The specific solutions of the implementation manners of the present disclosure are described as follows:

An audio interaction method includes:

determining a user attribute tag, and grouping users into N groups based on the user attribute tag, N being a positive integer that at least is 2;

recording an audio file of a user, and extracting decibel information of the audio file of the user from the recorded audio file of the user; and

comparing the extracted decibel information of the audio file of the user with decibel information of a user in another group different from a group the user is in, and presenting a comparison result.

An audio interaction apparatus includes an attribute tag receiving unit, an audio recording unit, and a comparison unit:

the attribute tag receiving unit being configured to determine a user attribute tag, and group users into N groups based on the user attribute tag, N being a positive integer that at least is 2;

the audio recording unit being configured to record an audio file of a user, and extract decibel information of the audio file of the user from the recorded audio file of the user; and

the comparison unit being configured to compare the extracted decibel information of the audio file of the user with decibel information of a user in another group different from a group the user is in, and present a comparison result.

An audio interaction system includes a client and a server:

the client being configured to determine a user attribute tag, record an audio file of a user, extract decibel information of the audio file of the user from the recorded audio file of the user, and send the user attribute tag and the extracted decibel information of the audio file of the user to the server; and present a comparison result sent by the server; and

the server being configured to group users into N groups based on the user attribute tag, N being a positive integer that at least is 2, compare the decibel information of the audio file of the user sent by the client with decibel information of a user in another group different from a group the user is in, and send the comparison result to the client.

It can be seen from the foregoing technical solutions that, in the implementation manners of the present disclosure, a user attribute tag is determined, and users are grouped into N groups based on the user attribute tag, N being a positive integer that at least is 2; an audio file of a user is recorded, and decibel information of the audio file of the user is extracted from the recorded audio file of the user; and the extracted decibel information of the audio file of the user is compared with decibel information of a user in another group different from a group the user is in, and a comparison result is presented. It can be seen that, after the implementation manners of the present disclosure are applied, interaction between grouped users is achieved in an audio manner, advantages of multimedia are fully used, and both an interactive format and interactive content are greatly improved, so that an interactive effect is better, thereby improving interactive efficiency.

In addition, in the implementation manners of the present disclosure, decibel information of a user is compared with decibel information of a user in another group, so that a text limitation of interactive manners of a text chat and voting is overcome, and as confrontational interaction is directly performed by using an audio, interaction approaches and manners are extended; in addition, such confrontational interaction is closer to a virtual reality, thereby further improving the interactive efficiency.

Moreover, interaction data generated during audio interaction can be shared in another application platform, thereby promoting efficient integration of the interaction data. In addition, the implementation manners of the present disclosure can be applied to various terminals, the implementation manners of the present disclosure can be used in cross-platform and cross-terminal manners, and therefore, the implementation manners of the present disclosure are widely applicable.

### BRIEF DESCRIPTION OF THE DRAWINGS

FIG. 1 is a flowchart of an audio interaction method according to an implementation manner of the present disclosure;

FIG. 2 is a schematic diagram of audio interaction of confrontation of supporters in a game according to an implementation manner of the present disclosure;

FIG. 3 is a schematic diagram of a decibel display of audio interaction in a game according to an implementation manner of the present disclosure;

FIG. 4 is a schematic structural diagram of an audio interaction apparatus according to an implementation manner of the present disclosure;

FIG. 5 is a schematic structural diagram of an audio interaction system according to an implementation manner of the present disclosure;

FIG. 6 is a schematic structural diagram of another audio interaction apparatus according to an implementation manner of the present disclosure; and

FIG. 7 is a schematic structural diagram of still another audio interaction apparatus according to an implementation manner of the present disclosure.

### DESCRIPTION OF EMBODIMENTS

To make the objectives, technical solutions, and advantages of the present disclosure clearer, the following further describes the present disclosure in detail with reference to the accompanying drawings.

In implementation manners of the present disclosure, a novel interactive manner of group confrontation is achieved based on audio interaction between users, which is particularly applicable to audio interaction between users during watching of a sports game. In addition, in the implementation manners of the present disclosure, preferably, audio file data and decibel data of a user are integrated to form a decibel curve chart, and the audio file data and the decibel data can be shared in another social networking service (SNS) platform through a uniform data interface.

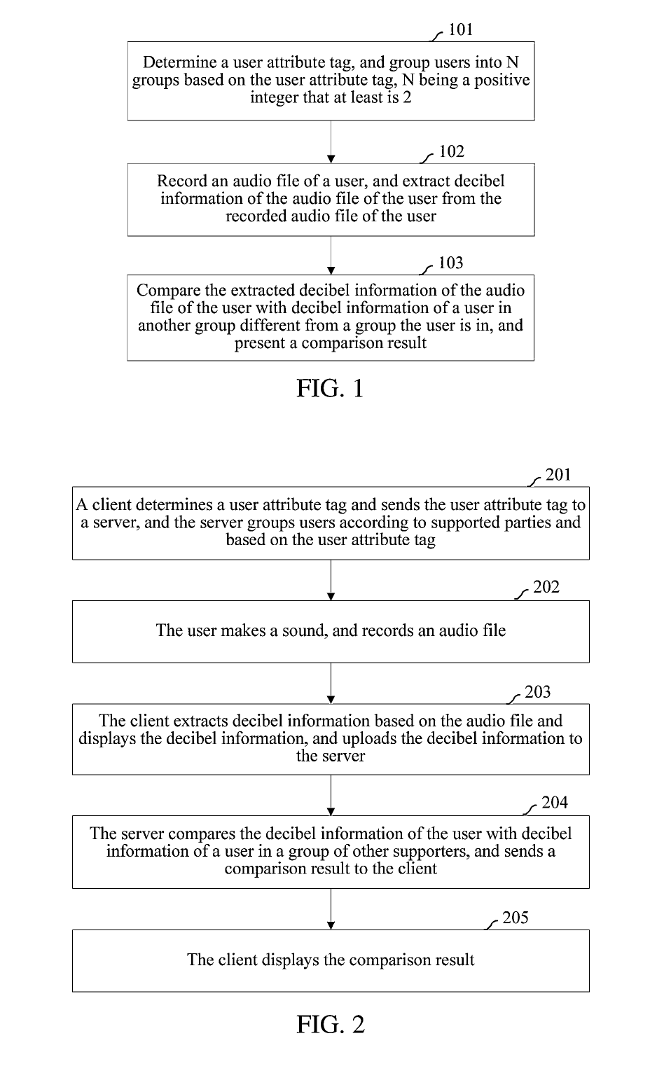

FIG. 1 is a flowchart of an audio interaction method according to an implementation manner of the present disclosure.

As shown in FIG. 1, the method includes the following steps:

Step 101: Determine a user attribute tag, and group users into N groups based on the user attribute tag, N being a positive integer that at least is 2.

Herein, selection of a user may be first received in a client, to determine a user attribute tag. The client may include, but is not limited to: a functional mobile phone, a smartphone, a palmtop computer, a PC, a tablet computer, or a personal digital assistant (PDA). In addition, when the client is specifically an intelligent terminal, an operating system that can be used by the client may include, but is not limited to: Android, iOS, Symbian, Windows Phone, BlackBerry OS, or Mac OS X.

The user attribute tag is used to perform confrontational grouping on users, and generally, a user voluntarily determines a user attribute tag. For example, the user attribute tag may specifically be a soccer fan attribute (that is, specifically supporting which soccer team) of the user, a geographical location attribute (such as the province of the user) of the user, or an age attribute (such as the age of the user) of the user. Based on different user attribute tags of users, the users are grouped according to types of the user attribute tags.

For example, assuming there are 6 users, that is, a user 1, a user 2, a user 3, a user 4, a user 5, and a user 6, where an attribute tag of the user 1 is a Manchester United fan, an attribute tag of the user 2 is a Chelsea fan, an attribute tag of the user 3 is a Manchester United fan, an attribute tag of the user 4 is a Manchester United fan, an attribute tag of the user 5 is a Chelsea fan, and an attribute tag of the user 6 is a Chelsea fan, the 6 users may be grouped into 2 groups according to types of the attribute tags, which separately are a Manchester United fan group and a Chelsea fan group. The Manchester United fan group includes the user 1, the user 3, and the user 4; and the Chelsea fan group includes the user 2, the user 5, and the user 6.

Based on a specific requirement of an application case, the number of groups may also be set flexibly. For example, during interaction of watching of a soccer game, because there are two confrontational teams, the number of groups may be set to 2 at this time; during interaction of watching of “Dou Dizhu”, because there are 3 confrontational parties, the number of groups may be set to 3 at this time; and during interaction of watching of “World Army Chess”, because there are 4 confrontation parties, the number of groups may be set to 4 at this time.

Specific grouping may be performed in a client, or may be performed in a server. When the grouping is performed in the server, the client first sends user information of users and corresponding user attribute tags to the server, and then the server groups the users according to the user attribute tags.

The client and the server may be connected in multiple manners, and may be connected in a wireless manner or connected in a wired manner. In this implementation manner of the present disclosure, the client and the server may specify specific communications protocols, and define, in these communications protocols, a format used by a data unit, information and definition that should be included in an information unit, a connection manner, and a time sequence of sending and receiving information, thereby ensuring that data in a network can be smoothly transmitted to a determined place.

Preferably, in this implementation manner of the present disclosure, the client may be in communication connection to the server by using multiple wireless communications networks. Communications manners between the client and the server may be classified into simplex communication, half-duplex communication, full-duplex communication, and the like according to a relationship between an information transmission direction and an information transmission time.

For example, a communications protocol that can be used by this implementation manner of the present disclosure includes, but is not limited to: the Transmission Control Protocol/Internet Protocol (TCP/IP), the HTTP, the Simple Mail Transfer Protocol (SMTP), or the Post Office Protocol Version 3 (POP3).

In addition, in this implementation manner of the present disclosure, the client may perform information interaction with the server by using multiple communications standards. For example, various communications standards such as Global System for Mobile Communications (GSM), Wideband Code Division Multiple Access (WCDMA), Code Division Multiple Access 2000 (CDMA-2000), and Time Division-Synchronous Code Division Multiple Access (TD-SCDMA) may be used.

Formats of information interaction between the client and the server may have multiple forms. For example, an information format may include, but is not limited to: an SMS message (SMS), an email, an IM message, multimedia messaging service (MMS), or a voice message.

Although some specific forms of formats of information interaction between clients, and between the client and the server are listed in detail above, a person skilled in the art may be aware that such listing is merely exemplary and is not intended to limit this implementation manner of the present disclosure.

Step 102: Record an audio file of a user, and extract decibel information of the audio file of the user from the recorded audio file of the user.

Herein, a user may watch a confrontational game in the client, and produce an audio (preferably, a comment audio or a cheering audio). The client records an audio file of a user, and extracts decibel information of the audio file of the user from the recorded audio file of the user. Preferably, a time period may be set for sound making, for example, 1 minute, without limiting a form and content of sound making by the user.

Specifically, the client may record the audio file of the user by using an Apple Lossless Audio Codec (ALAC) encoder, and read an average level and a peak level of each sound channel by using a timer callback function; or the client may record the audio file of the user by using a Free Lossless Audio Codec (FLAC) encoder, and read an average level and a peak level of each sound channel by using a timer callback function; or the client may record the audio file of the user by using an Adaptive Predictive Encoding (APE) encoder, and read an average level and a peak level of each sound channel by using a timer callback function. During audio recording, the average level and the peak level of each sound channel are read by using the timer callback function, which represent a decibel value of each sound channel, ranging between −100 to 0.

Although specific manners of recording the audio file of the user by the client are listed in detail above, a person skilled in the art may be aware that such listing is merely exemplary and is not intended to limit this implementation manner of the present disclosure.

In an implementation manner, a maximum decibel value or an average decibel value in a predetermined time period may be extracted from the recorded audio file of the user.

Step 103: Compare the extracted decibel information of the audio file of the user with decibel information of a user in another group different from a group the user is in, and present a comparison result.

After recording the audio file in the client, the user may upload the audio file to the server by using an http stream protocol interface. At the same time, the user invokes a data reporting interface, and submits the decibel information of the audio file of the user, personal information, and a user attribute tag to the server, and then the server performs a specific comparison operation.

For example, for a soccer game, data that needs to be stored in a server end includes: decibel values of home team fans and decibel values of guest team fans, where, preferably, 10 decibels are used as an interval for collecting statistics on user decibel values in different intervals. Preferably, statistics may also be collected on decibel values of a single user in latest 10 games. Shared memory storage may be used as a storage manner of the server, and a data structure thereof is preferably uses a hash manner. A decibel value submitted by a user is added to a total decibel value of a soccer team according to the soccer team supported by the user, and the value is added to user decibels in an interval according to the decibel interval. A location at which the user decibel is recorded and stored may be searched in a hash manner, and the number of stored games is determined; if the number of stored games is greater than 10 (the number may be adjusted accordingly), a game of a longer time is eliminated in a least recently used (lru) manner, and decibel data of a latest game is stored at the end of an array. When user interaction result information is read (that is, a percentage of fans of an opposite soccer team, whose decibel values are less than the decibel value of the users is read), first, the server reads an interval of the decibel value of the user by using a buffer, then reads, according to the interval, the number of fans, in the interval, of the soccer team opposite to the team supported by the user, and divides the total number of fans of the opposite soccer team by the number, that is, calculates a percentage of fans of the guest team, whose decibel values are less than the decibel value of the user.

Specifically:

In an implementation manner, when the client extracts a maximum decibel value in a predetermined time period from the recorded audio file of the user, a comparison operation of the server specifically includes: determining a decibel value interval to which the extracted maximum decibel value in the predetermined time period belongs; determining the number M1 of users, whose maximum decibel values are less than the decibel value interval, in users in another group different from the group the user is in; and using M1 divided by K as a comparison result, and presenting the comparison result, where K is the total number of the users in another group different from the group the user is in.

For example, assuming that a maximum decibel of an audio produced by a user is 40, and a decibel interval to which the maximum decibel of the audio of the user belongs and that is specified by the server is 40 to 50, at this time, the server buffers and reads, from a maximum decibel of audios of all supporters of the opposite soccer team, the total number, for example, 200, of supporters of the opposite soccer team whose decibel values are less than the interval (that is, 40 to 50). Then, the total number (assuming 400) of supporters of the opposite soccer team is divided by 200, to obtain 200/400=50/100, that is, a comparison result, and the comparison result can be presented flexibly in various manners, for example, “Congratulations, your maximum audio decibel defeats 50% of opposite fans!”.

In an implementation manner, when the client extracts an average decibel value in a predetermined time period from the recorded audio file of the user, a comparison operation of the server specifically includes: determining a decibel value interval to which the extracted average decibel value in the predetermined time period belongs; determining the number M2 of users, whose average decibel values are less than the decibel value interval, in users in another group different from the group the user is in; and using M2 divided by K as a comparison result, and presenting the comparison result, where K is the total number of users in another group different from the group the user is in.

For example, assuming that an average decibel of an audio produced by a user is 35, and a decibel interval to which the average decibel of the audio of the user belongs and that is specified by the server is 30 to 40, at this time, the server buffers and reads, from an average decibel of audios of all supporters of the opposite soccer team, the total number, for example, 100, of supporters of the opposite soccer team whose decibel values are less than the interval (that is, 30 to 40). Then, the total number (assuming 150) of supporters of the opposite soccer team is divided by 100, to obtain 100/150=66.7/100, that is, a comparison result, and the comparison result may be presented flexibly in various manners, for example, “Congratulations, your average audio decibel defeats 66.7% of opposite fans!”.

Preferably, before the server sends the comparison result to the client, the method further includes: verifying, by the server, whether an identity of the client is valid, and sending an information subscription candidate list to the client only when the identity of the client is valid, where the verifying, by the server, whether an identity of the client is valid includes: verifying whether a fingerprint of a client user is consistent with an authorized fingerprint, verifying whether an iris of the client user is consistent with an authorized iris, verifying whether an international mobile equipment identity (IEMI) of the client is valid, or whether a set screensaver password of the client is correct.

Preferably, the audio file of the user may be replayed in the client or the server. For example, a user audio file replay request may be received first; and then the recorded audio file of the user is extracted in response to the user audio file replay request, and the audio file of the user is replayed.

In addition, a maximum decibel value in the predetermined time period may be acquired based on the decibel information of the audio file of the user; and a decibel curve chart is drawn based on the decibel information of the audio file of the user, and the decibel curve chart and/or the maximum decibel value is presented. This implementation manner of the present disclosure can display a sound decibel frequency wave line and a maximum decibel value, and can replay an audio file of a user at any time.

Data such as the decibel curve chart, the recorded audio file of the user, and/or the maximum decibel value may also be pushed to various SNS platforms by using a uniformly set pushing interface, and the SNS platforms present the decibel curve chart, the recorded audio file of the user, and/or maximum decibel information. For example, an SNS platform includes, but is not limited to: a microblog, a blog, or personal cyberspace.

In specific implementation, an AVAudioToolBox architecture or an AVFoundation.framework architecture may be used in this implementation manner of the present disclosure. A system encoder is invoked by using the architecture, and an audio file stored during audio recording is invoked and played. First, a complete audio file is loaded to a system buffer area, then an encoder is invoked, and after information such as a buffer area, an audio format, and quality of an audio that needs to be played is set, a playback process is completed.

Based on the foregoing analysis, FIG. 2 is a schematic diagram of audio interaction of confrontation of supporters in a game according to an implementation manner of the present disclosure.

As shown in FIG. 2, the method includes:

Step 201: A client determines a user attribute tag and sends the user attribute tag to a server, and the server groups users according to supported parties of a confrontational game and based on the user attribute tag. The user attribute tag is used to perform confrontational grouping on users, and generally, a user voluntarily determines a user attribute tag.

Step 202: The user makes a sound, and the client records an audio file.

Step 203: The client extracts decibel information from the audio file, displays the decibel information in the client locally, and sends the decibel information to the server. Herein, during the display of the decibel information, the client may draw a decibel curve chart based on the decibel information of the audio file of the user, and presents the decibel curve chart and/or a maximum decibel value.

Step 204: The server compares the decibel information of the user with decibel information of a user in a group of other supporters, and sends a comparison result to the client.

Step 205: The client displays the comparison result.

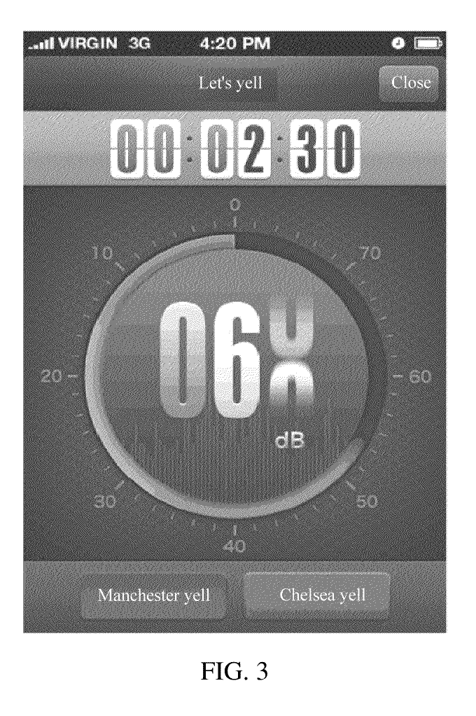

FIG. 3 is a schematic diagram of a decibel display of audio interaction in a game according to an implementation manner of the present disclosure. It can be seen from FIG. 3 that, a user can learn, from an interface, decibel information of an audio produced by the user, and select a user attribute tag by triggering a “Manchester yell” button or a “Chelsea yell” button.

Based on the foregoing detailed analysis, an implementation manner of the present disclosure further provides an audio interaction apparatus.

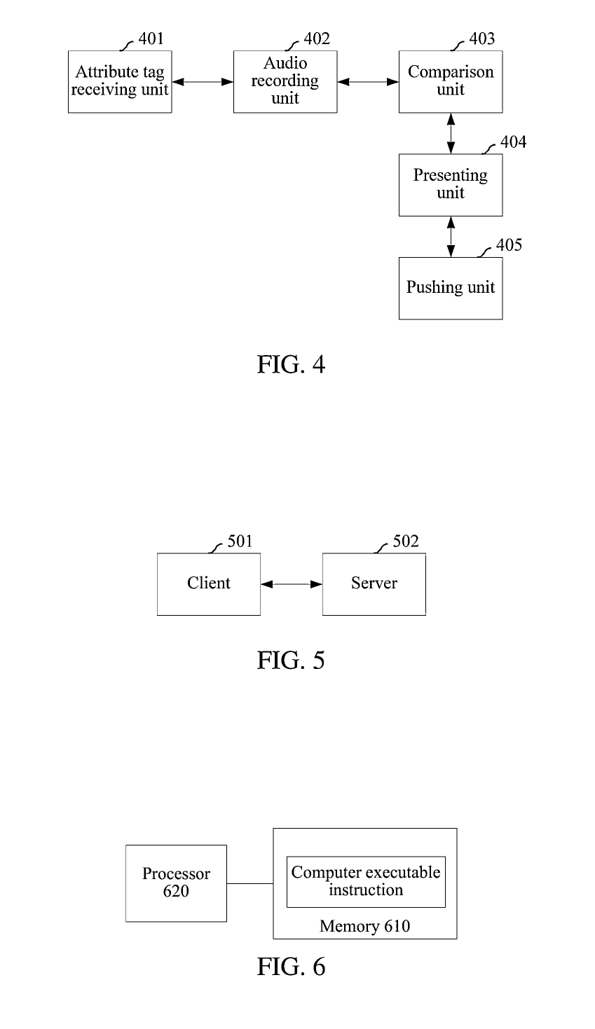

FIG. 4 is a schematic structural diagram of an audio interaction apparatus according to an implementation manner of the present disclosure. As shown in FIG. 4, the apparatus includes: an attribute tag receiving unit 401, an audio recording unit 402, and a comparison unit 403:

the attribute tag receiving unit 401 being configured to determine a user attribute tag, and group users into N groups based on the user attribute tag, N being a positive integer that at least is 2;

the audio recording unit 402 being configured to record an audio file of a user, and extract decibel information of the audio file of the user from the recorded audio file of the user; and

the comparison unit 403 being configured to compare the extracted decibel information of the audio file of the user with decibel information of a user in another group different from a group the user is in, and present a comparison result.

In an implementation manner, the apparatus further includes a presenting unit 404. In this case:

the audio recording unit 402 is configured to record an audio file of the user in a predetermined time period; and

the presenting unit 404 is configured to acquire a maximum decibel value in the predetermined time period based on the decibel information of the audio file of the user, draw a decibel curve chart based on the decibel information of the audio file of the user, and present the decibel curve chart and/or the maximum decibel value.

In an implementation manner, the presenting unit 404 is further configured to receive a user audio file replay request; and extract the recorded audio file of the user in response to the user audio file replay request, and replay the audio file of the user.

Specifically, the audio recording unit 402 is configured to record the audio file of the user by using an ALAC encoder, and read an average level and a peak level of each sound channel by using a timer callback function; or record the audio file of the user by using an FLAC encoder, and read an average level and a peak level of each sound channel by using a timer callback function; or record the audio file of the user by using an APE encoder, and read an average level and a peak level of each sound channel by using a timer callback function.

Preferably, the audio recording unit 402 is configured to extract a maximum decibel value in a predetermined time period from the recorded audio file of the user; and

the comparison unit 404 is configured to determine a decibel value interval to which the extracted maximum decibel value in the predetermined time period belongs; determine the number M1 of users, whose maximum decibel values are less than the decibel value interval, in users in another group different from the group the user is in; and use M1 divided by K as a comparison result, and present the comparison result, where K is the total number of the users in another group different from the group the user is in.

In an implementation manner, the audio recording unit 402 is configured to extract an average decibel value in a predetermined time period from the recorded audio file of the user; and

the comparison unit 404 is configured to determine a decibel value interval to which the extracted average decibel value in the predetermined time period belongs; determine the number M2 of users, whose average decibel value is less than the decibel value interval, in users in another group different from the group the user is in; and use M2 divided by K as a comparison result, and present the comparison result, where K is the total number of the users in another group different from the group the user is in.

The apparatus further includes a pushing unit 405; and

the pushing unit 405 is configured to push the decibel curve chart, the recorded audio file of the user, and/or the maximum decibel value to an SNS platform, where the SNS platform includes at least one of the following: a microblog, a blog, and personal cyberspace.

Based on the foregoing detailed analysis, an implementation manner of the present disclosure further provides an audio interaction system. In this system, a client-server architecture is used.

FIG. 5 is a schematic structural diagram of an audio interaction system according to an implementation manner of the present disclosure. As shown in FIG. 5, the system includes a client 501 and a server 502.

The client 501 may include, but is not limited to: a functional mobile phone, a smartphone, a palmtop computer, a PC, a tablet computer, or a PDA. In addition, when the client 501 is specifically an intelligent terminal, an operating system that can be used by the client 501 may specifically include, but is not limited to: Android, iOS, Symbian, Windows Phone, BlackBerry OS, or Mac OS X.

The client 501 and the server 502 may be connected in multiple manners, and may be connected in a wireless manner or connected in a wired manner. In this implementation manner of the present disclosure, the client 501 and the server 502 may specify specific communications protocols, and define, in these communications protocols, a format used by a data unit, information and definition that should be included in an information unit, a connection manner, and a time sequence of sending and receiving information, thereby ensuring that data in a network can be smoothly transmitted to a determined place.

Preferably, in this implementation manner of the present disclosure, the client 501 may be in communication connection to the server 502 by using multiple wireless communications networks. Communications manners between the client and the server may be classified into simplex communication, half-duplex communication, full-duplex communication, and the like according to a relationship between an information transmission direction and an information transmission time.

For example, a communications protocol that can be used by this implementation manner of the present disclosure includes but is not limited to: the TCP/IP, the HTTP, the SMTP, or the POP3.

In addition, in this implementation manner of the present disclosure, the client 501 may perform information interaction with the server 502 by using multiple communications standards. For example, various communications standards such as GSM, WCDMA, CDMA-2000, and TD-SCDMA may be used.

Formats of information interaction between the client 501 and the server 502 may have multiple forms. For example, an information format may include, but is not limited to: an SMS message (SMS), an email, an IM message, MMS, or a voice message.

Although some specific forms of formats of information interaction between clients 501, and between the client 501 and the server 502 are listed in detail above, a person skilled in the art may be aware that such listing is merely exemplary and is not intended to limit this implementation manner of the present disclosure.

Herein:

the client 501 is configured to determine a user attribute tag, record an audio file of a user, extract decibel information of the audio file of the user from the recorded audio file of the user, and send the user attribute tag and the extracted decibel information of the audio file of the user to the server 502; and present a comparison result sent by the server 502; and

the server 502 is configured to group users into N groups based on the user attribute tag, N being a positive integer that at least is 2, compare the decibel information of the audio file of the user sent by the client with decibel information of a user in another group different from a group the user is in, and send the comparison result to the client.

In an implementation manner, the client 501 is configured to record an audio file of the user in a predetermined time period, acquire a maximum decibel value in the predetermined time period based on the decibel information of the audio file of the user, draw a decibel curve chart based on the decibel information of the audio file of the user, and present the decibel curve chart and/or the maximum decibel value; and send the audio file of the user, the decibel curve chart, and/or the maximum decibel value to the server 502.

Specifically, the client 501 is configured to record the audio file of the user by using an ALAC encoder, and read an average level and a peak level of each sound channel by using a timer callback function; or record the audio file of the user by using an FLAC encoder, and read an average level and a peak level of each sound channel by using a timer callback function; or record the audio file of the user by using an APE encoder, and read an average level and a peak level of each sound channel by using a timer callback function.

In an implementation manner, the client 501 is configured to extract a maximum decibel value in a predetermined time period from the recorded audio file of the user; and the server 502 is configured to determine a decibel value interval to which the extracted maximum decibel value in the predetermined time period belongs; determine the number M1 of users, whose maximum decibel values are less than the decibel value interval, in users in another group different from the group the user is in; and use M1 divided by K as a comparison result, and present the comparison result, where K is the total number of the users in another group different from the group the user is in.

In an implementation manner, the client 501 is configured to extract an average decibel value in a predetermined time period from the recorded audio file of the user; and

the server 502 is configured to determine a decibel value interval to which the extracted average decibel value in the predetermined time period belongs; determine the number M2 of users, whose average decibel values are less than the decibel value interval, in users in another group different from the group the user is in; and use M2 divided by K as a comparison result, and present the comparison result, where K is the total number of the users in another group different from the group the user is in.

Preferably, the client 501 is further configured to push the decibel curve chart, the recorded audio file of the user, and/or the maximum decibel value to an SNS platform, where the SNS platform includes at least one of the following: a microblog, a blog, and personal cyberspace.

The apparatus shown in FIG. 4 may be integrated into various hardware entities of a communications network. For example, the audio interaction apparatus may be integrated into a device such as a functional mobile phone, a smartphone, a palmtop computer, a PC, a tablet computer, or a PDA.

In fact, the audio interaction apparatus provided by this implementation manner of the present disclosure may be specifically implemented in various manners. For example, the audio interaction apparatus may be compiled, by using an application programming interface that complies with a certain regulation, as a plug-in that is installed in an intelligent terminal, or may be encapsulated into an application program for a user to download and use.

When compiled as a plug-in, the account generating apparatus may be implemented in various plug-in forms such as ocx, dll, and cab. The audio interaction apparatus provided by this implementation manner of the present disclosure may also be implemented by using a specific technology, such as a Flash plug-in technology, a RealPlayer plug-in technology, an MMS plug-in technology, a MIDI staff plug-in technology, or an ActiveX plug-in technology. The plug-in may also be set as an accompanying and instrumental product of an APP, so that a user can produce an audio before, during, or after a game by selecting a supported game party, support a favorite game party by using a decibel value, which is compared with that of a supporter of the opposite party, so that a confrontational (PK) effect among user groups are obtained, and audio data, decibel data, and the like may be further shared in various platforms.

The audio interaction method provided by this implementation manner of the present disclosure may be stored in various storage mediums in an instruction storage manner or an instruction set storage manner. These storage mediums include, but are not limited to: a floppy disk, an optical disc, a DVD, a hard disk, a flash memory, a USB flash drive, a CF card, an SD card, an MMC card, an SM card, a memory stick, and an xD card.

In addition, the audio interaction method provided by this implementation manner of the present disclosure may also be applied to a storage medium based on a flash memory (Nand flash), such as USB flash drive, a CF card, an SD card, an SDHC card, an MMC card, an SM card, a memory stick, and an xD card.

Moreover, it should be clear that an operating system operated in a computer can be made, not only by executing program code read by the computer from a storage medium, but also by using an instruction based on the program code, to implement some or all actual operations, so as to implement functions of any embodiment in the foregoing embodiments.

For example, FIG. 6 is a schematic structural diagram of another audio interaction apparatus according to an implementation manner of the present disclosure. As shown in FIG. 6, the apparatus includes: a memory 610, and a processor 620 in communication connection to the memory 610, where the memory 610 stores a computer executable instruction that can be executed by the processor 620, where:

the computer executable instruction is used to instruct the processor 620 to determine a user attribute tag, record an audio file of a user, extract decibel information of the audio file of the user from the recorded audio file of the user, and send the user attribute tag and the extracted decibel information of the audio file of the user to the server; and present a comparison result sent by the server.

In an implementation manner, the computer executable instruction is further used to instruct the processor 620 to record an audio file of the user in a predetermined time period, acquire a maximum decibel value in the predetermined time period based on the decibel information of the audio file of the user, draw a decibel curve chart based on the decibel information of the audio file of the user, and present the decibel curve chart and/or the maximum decibel value.

Specifically, the computer executable instruction may be used to instruct the processor 620 to record the audio file of the user by using an ALAC encoder, and read an average level and a peak level of each sound channel by using a timer callback function; or instruct the processor 620 to record the audio file of the user by using an FLAC encoder, and read an average level and a peak level of each sound channel by using a timer callback function; or instruct the processor 620 to record the audio file of the user by using an APE encoder, and read an average level and a peak level of each sound channel by using a timer callback function.

In an implementation manner, the computer executable instruction may be used to instruct the processor 620 to extract a maximum decibel value or an average decibel value in a predetermined time period from the recorded audio file of the user, and send the extracted maximum decibel value or average decibel value in the predetermined time period to the server.

Preferably, the computer executable instruction may be further used to instruct the processor 620 to push the decibel curve chart, the recorded audio file of the user, and/or the maximum decibel value to an SNS platform, where the SNS platform includes at least one of the following: a microblog, a blog, and personal cyberspace.

The audio interaction apparatus shown in FIG. 6 may be a client apparatus.

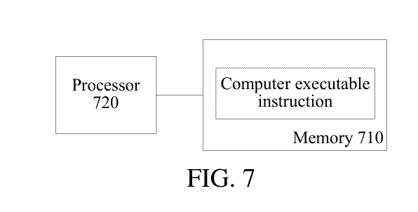

FIG. 7 is a schematic structural diagram of still another audio interaction apparatus according to an implementation manner of the present disclosure. As shown in FIG. 7, the apparatus includes: a memory 710, and a processor 720 in communication connection to the memory 710, where the memory 710 stores a computer executable instruction that can be executed by the processor 720, where:

the computer executable instruction is used to instruct the processor 720 to group users into N groups based on a user attribute tag determined by a client, N being a positive integer that at least is 2, compare decibel information of an audio file of a user sent by the client with decibel information of a user in another group different from a group the user is in, and present a comparison result, or send a comparison result to the client.

In an implementation manner, the computer executable instruction may be used to instruct the processor 720 to determine a decibel value interval to which a maximum decibel value in a predetermined time period extracted by the client belongs; determine the number M1 of users, whose maximum decibel values are less than the decibel value interval, in users in another group different from the group the user is in; and use M1 divided by K as a comparison result, and present the comparison result, or send the comparison result to the client, where K is the total number of the users in another group different from the group the user is in.

In an implementation manner, the computer executable instruction is further used to instruct the processor 720 to determine a decibel value interval to which an average decibel value in a predetermined time period extracted by the client belongs; determine the number M2 of users, whose average decibel values are less than the decibel value interval, in users in another group different from the group the user is in; and use M2 divided by K as a comparison result, and send the comparison result to the client, where K is the total number of the users in another group different from the group the user is in.

The audio interaction apparatus shown in FIG. 7 may be a server apparatus.

To sum up, in the implementation manners of the present disclosure, a user attribute tag is determined, and users are grouped into N groups based on the user attribute tag, N being a positive integer that at least is 2; an audio file of a user is recorded, and decibel information of the audio file of the user is extracted from the recorded audio file of the user; and the extracted decibel information of the audio file of the user is compared with decibel information of a user in another group different from a group the user is in, and a comparison result is presented. It can be seen that after the implementation manners of the present disclosure are applied, interaction between grouped users is achieved in an audio manner, both an interactive format and interactive content are greatly improved, and advantages of multimedia are fully used, so that an interactive effect is better, thereby improving interactive efficiency.

In addition, in the implementation manners of the present disclosure, decibel information of a user is compared with decibel information of a user in another group, so that a text limitation of interactive manners of a text chat and voting is overcome, and as confrontational interaction is directly performed by using an audio, interaction approaches and manners are extended; in addition, such confrontational interaction is closer to a virtual reality, thereby further improving the interactive efficiency.

Moreover, interaction data generated during audio interaction can be shared in another application platform, thereby promoting efficient integration of the interaction data. In addition, the implementation manners of the present disclosure can be applied to various terminals, and the implementation manners of the present disclosure can be used in cross-platform and cross-terminal manners, and therefore, are widely applicable.

A person skilled in the art may be aware that some exemplary instances of intelligent terminals and operating systems thereof are listed above in detail; however, such listing is merely provided for description, and is not intended to limit the protection scope of the implementation manners of the present disclosure.

What is claimed is:

1. An audio interaction method, comprising:
determining a user attribute tag, and grouping users into N groups based on the user attribute tag, N being a positive integer that at least is 2;
recording an audio file of a user, and extracting decibel information of the audio file of the user from the recorded audio file of the user; and
comparing the extracted decibel information of the audio file of the user with decibel information of a user in another group different from a group the user is in, and presenting a comparison result.

2. The audio interaction method according to claim 1, wherein the recording an audio file of a user is: recording an audio file of the user in a predetermined time period; and
the method further comprises:
acquiring a maximum decibel value in the predetermined time period based on the decibel information of the audio file of the user; and
drawing a decibel curve chart based on the decibel information of the audio file of the user, and presenting the decibel curve chart and/or the maximum decibel value.

3. The audio interaction method according to claim 1, wherein the method further comprises:
receiving a user audio file replay request; and
extracting the recorded audio file of the user in response to the user audio file replay request, and replaying the audio file of the user.

4. The audio interaction method according to claim 1, wherein the recording an audio file of a user, and extracting decibel information of the audio file of the user from the recorded audio file of the user comprises:
recording the audio file of the user by using an Apple Lossless Audio Codec (ALAC) encoder, and reading an average level and a peak level of each sound channel by using a timer callback function;
recording the audio file of the user by using a Free Lossless Audio Codec (FLAC) encoder, and reading an average level and a peak level of each sound channel by using a timer callback function; or
recording the audio file of the user by using an Adaptive Predictive Encoding (APE) encoder, and reading an average level and a peak level of each sound channel by using a timer callback function.

5. The audio interaction method according to claim 1, wherein the extracting decibel information of the audio file of the user from the recorded audio file of the user is: extracting a maximum decibel value in a predetermined time period from the recorded audio file of the user; and
the comparing the extracted decibel information of the audio file of the user with decibel information of a user in another group different from a group the user is in, and presenting a comparison result comprises:
determining a decibel value interval to which the extracted maximum decibel value in the predetermined time period belongs;
determining the number M1 of users, whose maximum decibel values are less than the decibel value interval, in users in another group different from the group the user is in; and
using M1 divided by K as a comparison result, and presenting the comparison result, wherein K is the total number of the users in another group different from the group the user is in.

6. The audio interaction method according to claim 1, wherein the extracting decibel information of the audio file of the user from the recorded audio file of the user is: extracting an average decibel value in a predetermined time period from the recorded audio file of the user; and
the comparing the extracted decibel information of the audio file of the user with decibel information of a user in another group different from a group the user is in, and presenting a comparison result comprises:
determining a decibel value interval to which the extracted average decibel value in the predetermined time period belongs;
determining the number M2 of users, whose average decibel values are less than the decibel value interval, in users in another group different from the group the user is in; and
using M2 divided by K as a comparison result, and presenting the comparison result, wherein K is the total number of the users in another group different from the group the user is in.

7. The audio interaction method according to claim 2, wherein the method further comprises:
pushing the decibel curve chart, the recorded audio file of the user, and/or the maximum decibel value to a social networking service (SNS) platform, wherein the SNS platform comprises at least one of the following: a microblog, a blog, and personal cyberspace; and
presenting, by the SNS platform, the decibel curve chart, the recorded audio file of the user, and/or maximum decibel value.

8. An audio interaction apparatus, comprising an attribute tag receiving unit, an audio recording unit, and a comparison unit; wherein,
the attribute tag receiving unit is configured to determine a user attribute tag, and group users into N groups based on the user attribute tag, N being a positive integer that at least is 2;
the audio recording unit is configured to record an audio file of a user, and extract decibel information of the audio file of the user from the recorded audio file of the user; and
the comparison unit is configured to compare the extracted decibel information of the audio file of the user with decibel information of a user in another group different from a group the user is in, and present a comparison result.

9. The audio interaction apparatus according to claim 8, wherein the apparatus further comprises a presenting unit;
the audio recording unit is configured to record an audio file of the user in a predetermined time period; and
the presenting unit is configured to acquire a maximum decibel value in the predetermined time period based on the decibel information of the audio file of the user, draw a decibel curve chart based on the decibel information of the audio file of the user, and present the decibel curve chart and/or the maximum decibel value.

10. The audio interaction apparatus according to claim 8, wherein
the presenting unit is further configured to receive a user audio file replay request; and extract the recorded audio file of the user in response to the user audio file replay request, and replay the audio file of the user.

11. The audio interaction apparatus according to claim 8, wherein
the audio recording unit is configured to record the audio file of the user by using an Apple Lossless Audio Codec (ALAC) encoder, and read an average level and a peak level of each sound channel by using a timer callback function; or
record the audio file of the user by using a Free Lossless Audio Codec (FLAC) encoder, and read an average level and a peak level of each sound channel by using a timer callback function; or
record the audio file of the user by using an Adaptive Predictive Encoding (APE) encoder, and read an average level and a peak level of each sound channel by using a timer callback function.

12. The audio interaction apparatus according to claim 8, wherein
the audio recording unit is configured to extract a maximum decibel value in a predetermined time period from the recorded audio file of the user; and
the comparison unit is configured to determine a decibel value interval to which the extracted maximum decibel value in the predetermined time period belongs; determine the number M1 of users, whose maximum decibel values are less than the decibel value interval, in users in another group different from the group the user is in; and use M1 divided by K as a comparison result, and present the comparison result, wherein K is the total number of the users in another group different from the group the user is in.

13. The audio interaction apparatus according to claim 8, wherein
the audio recording unit is configured to extract an average decibel value in a predetermined time period from the recorded audio file of the user; and
the comparison unit is configured to determine a decibel value interval to which the extracted average decibel value in the predetermined time period belongs; determine the number M2 of users, whose average decibel values are less than the decibel value interval, in users in another group different from the group the user is in; and use M2 divided by K as a comparison result, and present the comparison result, wherein K is the total number of the users in another group different from the group the user is in.

14. The audio interaction apparatus according to claim 8, wherein the apparatus further comprises a pushing unit; and
the pushing unit is configured to push the decibel curve chart, the recorded audio file of the user, and/or the maximum decibel value to a social networking service (SNS) platform, wherein the SNS platform comprises at least one of the following: a microblog, a blog, and personal cyberspace.

15. An audio interaction system, the system comprising a client and a server:
the client being configured to determine a user attribute tag, record an audio file of a user, extract decibel information of the audio file of the user from the recorded audio file of the user, and send the user attribute tag and the extracted decibel information of the audio file of the user to the server; and present a comparison result sent by the server; and
the server being configured to group users into N groups based on the user attribute tag, N being a positive integer that at least is 2, compare the decibel information of the audio file of the user sent by the client with decibel information of a user in another group different from a group the user is in, and send the comparison result to the client.

16. The audio interaction system according to claim 15, wherein
the client is configured to record an audio file of the user in a predetermined time period, acquire a maximum decibel value in the predetermined time period based on the decibel information of the audio file of the user, draw a decibel curve chart based on the decibel information of the audio file of the user, and present the decibel curve chart and/or the maximum decibel value; and send the audio file of the user, the decibel curve chart, and/or the maximum decibel value to the server.

17. The audio interaction system according to claim 15, wherein
the client is configured to record the audio file of the user by using an Apple Lossless Audio Codec (ALAC) encoder, and read an average level and a peak level of each sound channel by using a timer callback function; or record the audio file of the user by using a Free Lossless Audio Codec (FLAC) encoder, and read an average level and a peak level of each sound channel by using a timer callback function; or record the audio file of the user by using an Adaptive Predictive Encoding (APE) encoder, and read an average level and a peak level of each sound channel by using a timer callback function.

18. The audio interaction system according to claim 15, wherein
the client is configured to extract a maximum decibel value in a predetermined time period from the recorded audio file of the user; and
the server is configured to determine a decibel value interval to which the extracted maximum decibel value in the predetermined time period belongs; determine the number M1 of users, whose maximum decibel values are less than the decibel value interval, in users in another group different from the group the user is in; and use M1 divided by K as a comparison result, and present the comparison result or send the comparison result to the client, wherein K is the total number of the users in another group different from the group the user is in.

19. The audio interaction system according to claim 15, wherein
the client is configured to extract an average decibel value in a predetermined time period from the recorded audio file of the user; and
the server is configured to determine a decibel value interval to which the extracted average decibel value in the predetermined time period belongs; determine the number M2 of users, whose average decibel values are less than the decibel value interval, in users in another group different from the group the user is in; and use M2 divided by K as a comparison result, and present the comparison result or send the comparison result to the client, wherein K is the total number of the users in another group different from the group the user is in.

20. The audio interaction system according to claim 15, wherein
the client is further configured to push the decibel curve chart, the recorded audio file of the user, and/or the maximum decibel value to a social networking service (SNS) platform, wherein the SNS platform comprises at least one of the following: a microblog, a blog, and personal cyberspace.
